(19) United States
(12) Patent Application Publication
(10) Pub. No.: US 2023/0252691 A1
(43) Pub. Date: Aug. 10, 2023

(54) PASSTHROUGH WINDOW OBJECT LOCATOR IN AN ARTIFICIAL REALITY SYSTEM

(71) Applicant: Meta Platforms Technologies, LLC, Menlo Park, CA (US)

(72) Inventors: Britt Miura, Menlo Park, CA (US); Viraj Ajmeri, Redwood City, CA (US); James Michael-K O'Donnell, Pacifica, CA (US); Flávio Mattos de Carvalho, San Mateo, CA (US)

(21) Appl. No.: 18/301,078

(22) Filed: Apr. 14, 2023

Related U.S. Application Data
(63) Continuation of application No. 16/720,699, filed on Dec. 19, 2019.

(51) Int. Cl. G06T 11/00; G06F 3/033; G06F 3/01; G06T 7/20

(52) U.S. Cl. CPC G06T 11/00; G06F 3/033; G06F 3/013; G06T 7/20

(57) ABSTRACT

This disclosure describes an artificial reality system that assists a user in finding, locating, and/or taking possession of an object. In one example, this disclosure describes a system that includes a head-mounted display (HMD), capable of being worn by a user; a mapping engine configured to determine a map of a physical environment including position information about the HMD and an object; and an application engine configured to: detect execution of an application that operates using the object, determine that the object is not in possession of the user, and responsive to detecting execution of the application and determining that the object is not in possession of the user, generate artificial reality content that includes a passthrough window positioned to include the object.

### TECHNICAL FIELD

This disclosure generally relates to artificial reality systems, such as virtual reality, mixed reality and/or augmented reality systems, and more particularly, to presentation of content and performing operations in artificial reality applications.

### BACKGROUND

Artificial reality systems are becoming increasingly ubiquitous with applications in many fields such as computer gaming, health and safety, industrial, and education. As a few examples, artificial reality systems are being incorporated into mobile devices, gaming consoles, personal computers, movie theaters, and theme parks. In general, artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof.

Typical artificial reality systems include one or more devices for rendering and displaying and/or presenting content. As one example, an artificial reality system may incorporate a head-mounted display (HMD) worn by a user and configured to output artificial reality content to the user. The artificial reality content may include a number of different types of artificial reality content, including see-through AR, overlay AR, completely-generated content, generated content combined with captured content (e.g., real-world video and/or images), or other types. During operation, the user typically interacts with the artificial reality system to select content, launch applications or otherwise configure the system.

### SUMMARY

This disclosure describes an artificial reality system that assists a user in finding, locating, and/or taking possession of an object in the physical environment. Techniques described herein include determining a specific physical object may be used by a user in connection with artificial reality content being presented to a user or in connection with an artificial reality application. In some examples, such an object may be a controller or other input device for use when interacting with an artificial reality environment. In other examples, however, such an object may be a physical object other than an input device.

Techniques described herein also include generating content for display that includes a passthrough window within artificial reality content. In some examples, such a passthrough window may provide a view into the physical environment while the user is interacting with a virtual reality environment, thereby enabling a user to see aspects or specific objects within the physical environment, which may be helpful when the user attempts to locate or take possession of an object. The passthrough window may be positioned within the artificial reality content presented to the user so that an object can be seen and located by the user. Techniques described herein also include updating the artificial reality content and/or the passthrough window as the user moves toward the object or as the object itself moves.

In one specific example, an artificial reality system may determine that a user may wish to use and/or take possession of an object, and may present artificial reality content in a manner that enables the user to determine the location of the object. In another example, this disclosure describes operations performed by a system comprising: a head-mounted display (HMD), capable of being worn by a user; a mapping engine configured to determine a map of a physical environment including position information about the HMD and an object; and an application engine configured to: detect execution of an application that operates using the object, determine that the object is not in possession of the user, and responsive to detecting execution of the application and determining that the object is not in possession of the user, generate artificial reality content that includes a passthrough window positioned to include the object.

In another example, this disclosure describes a method comprising detecting, by an artificial reality system including a head mounted display and a mapping engine, execution of an application that operates using an object; determining, by the artificial reality system and based on a map determined by the mapping engine, that the object is not in possession of the user; and responsive to detecting execution of the application and determining that the object is not in possession of the user, generating, by the artificial reality system, artificial reality content that includes a passthrough window positioned to include the object.

In another example, this disclosure describes a non-transitory computer-readable medium comprising instructions for causing processing circuitry of an artificial reality system including a head mounted display and a mapping engine to perform operations comprising: detecting execution of an artificial reality application that operates using an object; determining that the object is not in possession of the user; and responsive to detecting execution of the application and determining that the object is not in possession of the user, generating artificial reality content that includes a passthrough window positioned to include the object.

### BRIEF DESCRIPTION OF THE DRAWINGS

FIG. 1 is a conceptual diagram illustrating an example artificial reality system that generates artificial reality content, in accordance with one or more aspects of the present disclosure.

FIG. 2 is an illustration depicting an example head-mounted display configured to operate in accordance with the techniques of the disclosure.

FIG. 3 is a block diagram showing example implementations of an example console and an example HMD, in accordance with one or more aspects of the present disclosure.

FIG. 4 is a block diagram depicting an example of a user device for an artificial reality system, in accordance with one or more aspects of the present disclosure.

FIG. 5A, FIG. 5B, FIG. 5C, FIG. 5D, and FIG. 5E are conceptual diagrams illustrating an example artificial reality system that may use one or more controllers, in accordance with one or more aspects of the present disclosure.

FIG. 6 is a conceptual diagram illustrating an example artificial reality system that generates artificial reality content that assists in finding one or more objects not within a field of view of user 101.

FIG. 7 is a flow diagram illustrating operations performed by an example artificial reality system in accordance with one or more aspects of the present disclosure.

### DETAILED DESCRIPTION

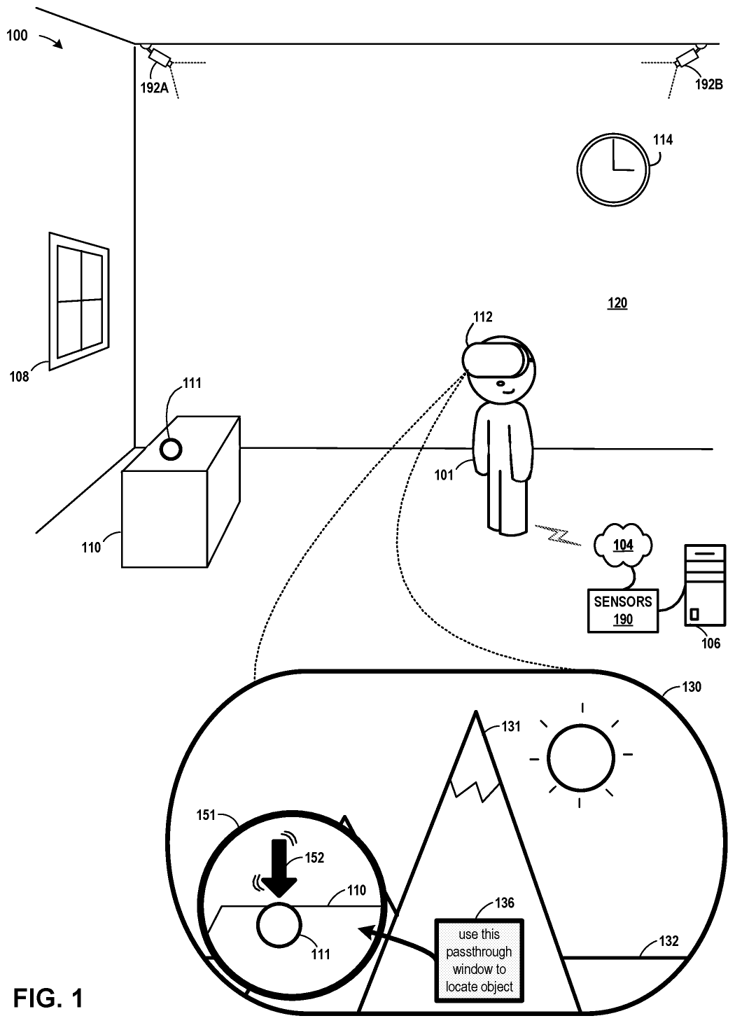

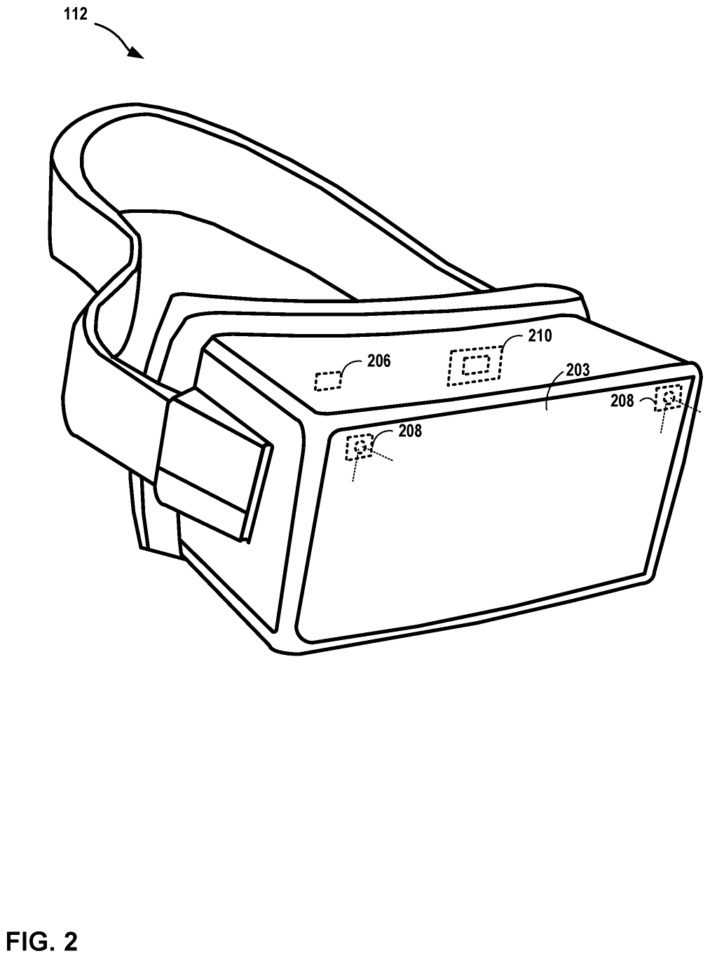

FIG. 1 is a conceptual diagram illustrating operations performed by an example artificial reality system, in accordance with one or more aspects of the present disclosure. In FIG. 1, artificial reality system 100 is depicted within or operating on physical environment 120. Physical environment 120 is shown as a room that includes user 101 and a number of real-world or physical objects, including HMD 112, window 108, table 110, object 111, and wall clock 114. In the example of FIG. 1, user 101 is wearing HMD 112, and object 111 is resting on table 110. User 101 is facing table 110 and the wall that includes window 108.

Artificial reality system 100 includes head-mounted display (HMD) 112, console 106, one or more sensors 190, and cameras 192A and 192B (collectively “cameras 192,” representing any number of cameras). Although in some examples, external sensors 190 and cameras 192 may be stationary devices (e.g., affixed to the wall), in other examples one or more of external sensors 190 and/or cameras 192 may be included within HMD 112, within a user device (not shown), or within any other device or system. As shown in FIG. 1, HMD 112 is typically worn by user 101 and includes an electronic display and optical assembly for presenting artificial reality content 130 to the user. In addition, HMD 112 may, in some examples, include one or more sensors (e.g., accelerometers) for tracking motion of the HMD and may include one or more image capture devices, e.g., cameras, line scanners and the like, for capturing image data of the surrounding environment.

Artificial reality system 100 may use information obtained from a real-world or physical three-dimensional (3D) environment to render artificial reality content for display by HMD 112, thereby presenting the content to user 101. In FIG. 1, user 101 views and/or is presented with artificial reality content 130 constructed and rendered by an artificial reality application executing on console 106 and/or HMD 112. Artificial reality content 130 may include images of physical objects within physical environment 120, including one or more physical items within physical environment 120 or in other situations, the artificial reality content might include few or no images of physical objects (e.g., artificial reality content 122B and 122C).

In FIG. 1, console 106 is shown as a single computing device, such as a gaming console, workstation, a desktop computer, or a laptop. In other examples, console 106 may be distributed across a plurality of computing devices, such as a distributed computing network, a data center, or a cloud computing system. HMD 112, console 106, external sensors 190, and cameras 192, may, as illustrated, be communicatively coupled via network 104, which may be a wired or wireless network, such as Wi-Fi, a mesh network or a short-range wireless communication medium. In some examples, user 101 may use one or more controllers (not shown) to perform gestures or other actions. In such an example, such controllers may be in communication with HMD 112 using near-field communication or short-range wireless communication such as Bluetooth, using wired communication links, or using another type of communication links. Although HMD 112 is shown in FIG. 1 as being in communication with (e.g., tethered to) or in wireless communication with, console 106, in some implementations HMD 112 operates as a stand-alone, mobile artificial reality system. As such, some or all functionality attributed to console 106 in this disclosure may be distributed among one or more user devices, such as one or more instances of HMD 112.

In some examples, an artificial reality application executing on console 106 and/or HMD 112 presents artificial reality content to user 101 based on a current viewing perspective for user 101. That is, in FIG. 1, the artificial reality application constructs artificial content by tracking and computing pose information for a frame of reference for HMD 112, and uses data received from HMD 112, external sensors 190, and/or cameras 192 to capture 3D information within the real-word, physical 3D environment 120, such as motion by user 101 and/or tracking information with respect to user 101 and one or more physical objects, for use in computing updated pose information for a corresponding frame of reference of HMDs 112 (or another user device). As one example, the artificial reality application may render, based on a current viewing perspective determined for HMD 112, an artificial reality environment, including artificial reality content 130 having, in some cases, artificial reality content overlaid upon images of physical or real-world objects (e.g., window 108). Further, from the perspective of HMD 112, artificial reality system 100 renders artificial reality content based upon the estimated positions and poses for user 101 and other physical objects.

In some examples, artificial reality system 100 may present an artificial reality environment or system in which user 101 may use one or more physical objects. For example, in some artificial reality applications, such as games, user 101 may interact with artificial reality content using one or more physical input devices that operate as controllers. Similarly, in some artificial reality applications, user 101 may interact with artificial reality content using other types of input devices, such as a physical stylus, keyboard, or pointing device. In other examples, some artificial reality applications or modes may require that user 101 use some other object, such as a physical ball, tennis racket, or a mobile phone or other personal communication device. In still other examples, user 101 may be required or encouraged to wear a specific article of clothing (e.g., hat, vest, shoes). In such examples, artificial reality system 100 may be configured to enable user 101 to use such objects when interacting with an artificial reality application or mode. However, to do so, user 101 typically needs to have physical possession of such objects (e.g., holding controllers, carrying a ball, holding a mobile phone, or wearing a hat, vest, or shoes).

Yet if user 101 doesn't have physical possession of one or more objects that are used when operating or using artificial reality system 100, user 101 may seek to find such objects within physical environment 120. In such a situation, user 101 may be tempted to remove HMD 112, because finding a physical object within a physical space is sometimes easier (or at least tends to be a more familiar task) when user 101 is not wearing HMD 112. As a result, user 101 might remove HMD 112 in order to find the desired physical object within physical environment 120. However, removing HMD 112 tends to disrupt the flow of artificial reality system 100, and may detract from the experience of artificial reality system 100. In some examples, techniques are described herein to facilitate or enhance the ability of user 101 to find physical objects in physical environment 120 while user 101 is wearing HMD 112.

In accordance with one or more aspects of the present disclosure, artificial reality system 100 may present artificial reality content that assists user 101 in finding and/or locating an object, such as object 111, that may be used when using artificial reality system 100. For instance, in an example that can be described with reference to FIG. 1, HMD 112, external sensors 190, and/or cameras 192 capture images within physical environment 120. HMD 112 detects information about a current pose of user 101. Console 106 receives such images and information about the current pose of user 101 and determines the position of physical objects within physical environment 120, including user 101, object 111, and table 110. Console 106 determines, based on the position of physical objects within physical environment 120 and the pose information, that user 101 is standing within physical environment 120 in front of table 110. Based on the position information and pose information, console 106 generates information sufficient to present artificial reality content 130. Console 106 causes HMD 112 to present artificial reality content 130 to user 101 within HMD 112 in the manner shown in FIG. 1.

In FIG. 1, artificial reality content 130 includes various virtual objects, including one or more virtual mountains 131 shown rising from virtual horizon 132. Such virtual objects may correspond to content presented pursuant to an artificial reality presentation, game, or application. In the example of FIG. 1, however, the artificial reality presentation, game, or application being presented to user 101 within HMD 112 may require that user 101 possess object 111. Accordingly, when generating information sufficient to present artificial reality content 130, console 106 includes information enabling presentation of passthrough window 151, positioned at a location within artificial reality content 130 such that object 111 is visible within passthrough window 151.

In FIG. 1, therefore, passthrough window 151 provides a reality passthrough view in which object 111 and the physical environment near object 111 is visible. Passthrough window 151 may present an image of object 111 that has been captured by HMD 112, so that object 111 appears within window 151 from the perspective of user 101. In other examples, however, passthrough window 151 may present an image of object 111 captured any other camera within the physical environment 120 (e.g., sensors 190 or cameras 192).

In passthrough window 151, object 111 is shown positioned near the edge of table 110. In some examples, passthrough window 151 may also include arrow 152, which may serve as an augmented reality marker that helps user 101 to locate object 111 within passthrough window 151. In some examples, object 111 may be highlighted, animated, or otherwise presented in a way that may help user 101 in locating object 111 within passthrough window 151. Alternatively, or in addition, arrow 152 may be animated or may move in some way (e.g., bounce) near object 111. Further, in some examples, artificial reality content 130 may include prompt 136 (overlaid on virtual content in artificial reality content 130). Prompt 136 may inform user 101 or direct, suggest, or otherwise indicate to user 101 that object 111 may be used in connection with the current artificial reality application. In addition, prompt 136 may suggest to user 101 that passthrough window 151 may be used to locate and/or pick up object 111 (e.g., without requiring removal of HMD 112).

In some examples, passthrough window 151 may be presented in response to user input requesting the passthrough window. In one such example, user 101 may simply say “show me my controller,” and console 106 may present passthrough window 151.

Console 106 may update artificial reality content 130 as user 101 moves. For instance, in some examples, HMD 112, external sensors 190, and/or cameras 192 may capture images within physical environment 120. Console 106 may receive information about the images within physical environment 120. Console 106 may determine, based on the information about the images, that user 101 has moved. In response to such a determination, console 106 may update artificial reality content 130 to reflect a new position, pose, and/or gaze of user 101. In such an example, passthrough window 151 may be positioned in a different location within 130. In addition, virtual content may also be modified or relocated within artificial reality content 130. For example, passthrough window 151 may be positioned in a location within artificial reality content 130 that provides user 101 with a window for viewing object 111 where object 111 would be located in the field of view of user 101 if user 101 were not wearing HMD 112.

Console 106 may update artificial reality content 130 as object 111 moves. For instance, in some examples, object 111 may tend to be stationary, particularly if user 101 is not in the possession of object 111 (e.g., where object 111 is a controller resting on table 110). However, where object 111 is easily put in motion (e.g., is a ball), or where object 111 happens to be attached to something that might move (e.g., if object 111 is a dog collar, or object 111 is a shoe worn by another user), object 111 may, in some examples, move. In such an example, HMD 112, external sensors 190, and/or cameras 192 may capture images within physical environment 120. In some examples (e.g., where object 111 is a controller), object 111 may alternatively or in addition emit light or signals that one or more of HMD 112, external sensors 190, and/or camera 192 capture. Console 106 may receive information about the images, captured light, and/or signals from physical environment 120. Console 106 may identify object 111 within the images or other information captured by HMD 112, external sensors 190, and/or cameras 192. To identify object 111, console 106 may apply a machine learning algorithm trained to identify, from images, the specific object represented by object 111. Console 106 may determine, based on the received information, that object 111 has moved or is moving. In response to such a determination, console 106 may update artificial reality content 130 to reflect a new location of object 111. In such an example, when 130 is updated, passthrough window 151 may be positioned in a different location within artificial reality content 130.

The techniques described herein may provide certain technical advantages. For instance, by enabling user 101 to find, pick up, and/or possess one or more objects 111 while still wearing HMD 112, artificial reality system 100 may enable the flow of artificial reality content being presented within HMD 112 to progress more naturally, thereby providing a more realistic, seamless, and/or immersive experience. Similarly, by avoiding situations or instances in which user 101 might be tempted to remove HMD 112, artificial reality system 100 may enable the flow of artificial reality content being presented within HMD 112 to progress more naturally, thereby providing a more realistic, seamless, and/or immersive experience. By enabling a more seamless experience, fewer processing operations may be needed to reinitiate or present disrupted artificial reality user interface flows or workflows. Further, by avoiding disrupted artificial reality user interface flows or workflows, artificial reality system 100 might avoid having to perform additional processing to resume flows.

In addition, by providing content or functionality that enables user 101 to locate one or more objects 111 more quickly, artificial reality system 100 may perform fewer processing operations to guide user 101 to object 111. By performing fewer processing operations, artificial reality system 100 may consume not only fewer processing cycles, but also less power. As described herein, techniques for enabling user 101 to locate objects 111 more quickly may include, but are not necessarily limited to, a passthrough window presented within artificial reality content.

FIG. 2 is an illustration depicting an example HMD 112 configured to operate in accordance with the techniques of the disclosure. HMD 112 of FIG. 2 may be an example of HMD 112 of FIG. 1. HMD 112 may be part of an artificial reality system, such as artificial reality system 100, or may operate as a stand-alone, mobile artificial realty system configured to implement the techniques described herein. HMD 112 may include a mobile device (e.g., a smart phone) that is removable from the body of the HMD 112.

In the example of FIG. 2, HMD 112 includes a front rigid body and a band to secure HMD 112 to a user. In addition, HMD 112 includes an interior-facing electronic display 203 configured to present artificial reality content to the user. Electronic display 203 may be any suitable display technology, such as liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating visual output. In some examples, the electronic display is a stereoscopic display for providing separate images to each eye of the user. In some examples, the known orientation and position of display 203 relative to the front rigid body of HMD 112 is used as a frame of reference, also referred to as a local origin, when tracking the position and orientation of HMD 112 for rendering artificial reality content according to a current viewing perspective of HMD 112 and the user.

In the example of FIG. 2, HMD 112 further includes one or more sensors 206, such as one or more accelerometers (also referred to as inertial measurement units or “IMUs”) that output data indicative of current acceleration of HMD 112, GPS sensors that output data indicative of a location of HMD 112, radar or sonar sensors that output data indicative of distances of the HMD 112 from various objects, or other sensors that provide indications of a location or orientation of HMD 112 or other objects within a physical 3D environment. Moreover, HMD 112 may include one or more integrated sensor devices 208, such as a microphone, audio sensor, a video camera, laser scanner, Doppler radar scanner, depth scanner, or the like, configured to output audio or image data representative of a surrounding real-world environment. HMD 112 includes an internal control unit 210, which may include an internal power source and one or more printed-circuit boards having one or more processors, memory, and hardware to provide an operating environment for executing programmable operations to process sensed data and present artificial-reality content on display 203. Internal control unit 210 may be part of a removable computing device, such as a smart phone.

Although illustrated in FIG. 2 having a specific configuration and structure, HMD 112 may take any of a number of forms. For example, in some implementations, HMD 112 might resemble glasses or may have a different form. Also, although HMD 112 may be configured with a display 203 for presenting representations or images of physical content, in other examples, HMD 112 may include a transparent or partially transparent viewing lens, enabling see-through artificial reality (i.e., “STAR”). Further, HMD may implement features based on wave guides or other STAR technologies.

In accordance with the techniques described herein, control unit 210 is configured to present content within the context of a physical environment that may include one or more physical objects that a user may wish to locate. For example, HMD 112 may compute, based on sensed data generated by motion sensors 206 and/or audio and image data captured by sensor devices 208, a current pose for a frame of reference of HMD 112. Control unit 210 may include a pose tracking unit, which can execute software for processing the sensed data and/or images to compute the current pose. Control unit 210 may store a master 3D map for a physical environment and compare processed images to the master 3D map to compute the current pose. Alternatively, or additionally, control unit 210 may compute the current pose based on sensor data generated by sensors 206. Based on the computed current pose, control unit 210 may render artificial reality content corresponding to the master 3D map for an artificial reality application, and control unit 210 may display the artificial reality content via the electronic display 203.

As another example, control unit 210 may generate mapping information for the physical 3D environment in which the HMD 112 is operating and send, to a console or one or more other computing devices (such as one or more other HMDs), via a wired or wireless communication session(s), the mapping information. In this way, HMD 112 may contribute mapping information for collaborate generation of the master 3D map for the physical 3D environment. Mapping information may include images captured by sensor devices 208, tracking information in the form of indications of the computed local poses, or tracking information that provide indications of a location or orientation of HMD 112 within a physical 3D environment (such as sensor data generated by sensors 206), for example.

In some examples, in accordance with the techniques described herein, control unit 210 may peer with one or more controllers for HMD 112 (controllers not shown in FIG. 2). Control unit 210 may receive sensor data from the controllers that provides indications of user inputs or controller orientations or locations within the physical 3D environment or relative to HMD 112. Control unit 210 may send representations of the sensor data to a console for processing by the artificial reality application, where the indications may be event data for an artificial reality application. Control unit 210 may execute the artificial reality application to process the sensor data.

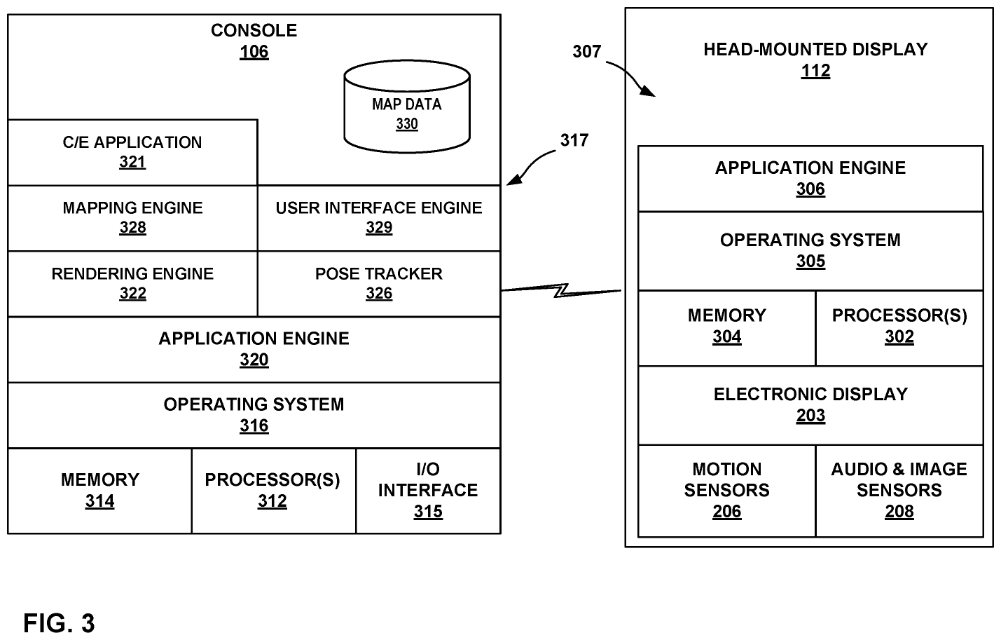

FIG. 3 is a block diagram showing example implementations of an example console and an example HMD, in accordance with one or more aspects of the present disclosure. Although the block diagram illustrated in FIG. 3 is described with reference to HMD 112, in other examples, functions and/or operations attributed to HMD 112 may be performed by a different device or system, such as a user device as referenced in connection with FIG. 1.

In the example of FIG. 3, HMD 112 includes one or more processors 302 and memory 304 that, in some examples, provide a computer platform for executing an operation system 305, which may be an embedded and near (or seemingly-near) real-time multitasking operating system. In turn, operating system 305 provides a multitasking operating environment for executing one or more software components 307. Processors 302 are coupled to electronic display 203 (see FIG. 2). HMD 112 is shown including motion sensors 206 and sensor devices 208 coupled to processor 302, but in other examples, HMD 112 may include neither or merely either of motion sensors 206 and/or sensor devices 208. In some examples, processors 302 and memory 304 may be separate, discrete components. In other examples, memory 304 may be on-chip memory collocated with processors 302 within a single integrated circuit. The memory 304, processors 302, operating system 305, and application engine 340 components may collectively represent an example of internal control unit 210 of FIG. 2.

HMD 112 may include user input devices, such as a touchscreen or other presence-sensitive screen example of electronic display 203, microphone, controllers, buttons, keyboard, and so forth. Application engine 340 may generate and present a login interface via electronic display 203. A user of HMD 112 may use the user interface devices to input, using the login interface, login information for the user. HMD 112 may send the login information to console 106 to log the user into the artificial reality system.

Operating system 305 provides an operating environment for executing one or more software components, which include application engine 306, which may be implemented as any type of appropriate module. Application engine 306 may be an artificial reality application having one or more processes. Application engine 306 may send, to console 106 as mapping information using an I/O interface (not shown in FIG. 3) via a network or other communication link, representations of sensor data generated by motion sensors 206 or images generated by sensor devices 208. The artificial reality application may be, e.g., a teleconference application, a gaming application, a navigation application, an educational application, or training or simulation application, for example.

Console 106 may be implemented by any suitable computing system capable of interfacing with user devices (e.g., HMDs 112) of an artificial reality system. In some examples, console 106 interfaces with HMDs 112 to augment content that may be within physical environment 120, or to present artificial reality content that may include a passthrough window that presents images (or videos) of the physical environment near where one or more objects are located within the physical environment. Such images may, in some examples, reveal the location of one or more objects 111 that a user may wish to locate. In some examples, console 106 generates, based at least on mapping information received from one or more HMDs 112, external sensors 190, and/or cameras 192, a master 3D map of a physical 3D environment in which users, physical devices, and other physical objects are located. In some examples, console 106 is a single computing device, such as a workstation, a desktop computer, a laptop. In some examples, at least a portion of console 106, such as processors 352 and/or memory 354, may be distributed across one or more computing devices, a cloud computing system, a data center, or across a network, such as the Internet, another public or private communications network, for instance, broadband, cellular, Wi-Fi, and/or other types of communication networks, for transmitting data between computing systems, servers, and computing devices.

In the example of FIG. 3, console 106 includes one or more processors 312 and memory 314 that provide a computer platform for executing an operating system 316. In turn, operating system 316 provides an operating environment for executing one or more software components 317. Processors 312 are coupled to I/O interface 315, which provides one or more I/O interfaces for communicating with external devices, such as a keyboard, game controllers, display devices, image capture devices, and the like. Moreover, I/O interface 315 may include one or more wired or wireless network interface cards (NICs) for communicating with a network, such as network 104 (see, e.g., FIG. 1). Each of processors 302, 312 may comprise any one or more of a multi-core processor, a controller, a digital signal processor (DSP), an application specific integrated circuit (ASIC), a field-programmable gate array (FPGA), or equivalent discrete or integrated logic circuitry. Memory 304, 314 may comprise any form of memory for storing data and executable software instructions, such as random-access memory (RAM), read-only memory (ROM), programmable read-only memory (PROM), erasable programmable read-only memory (EPROM), electronically erasable programmable read-only memory (EEPROM), and/or Flash memory. Software components 317 of console 106 operate to provide an overall artificial reality application. In the example of FIG. 3, software components 317 be represented by modules as described herein, including application engine 320, rendering engine 322, pose tracker 326, mapping engine 328, and user interface engine 329.

Application engine 320 includes functionality to provide and present an artificial reality application, e.g., a teleconference application, a gaming application, a navigation application, an educational application, training or simulation applications, and the like. Application engine 320 and application engine 340 may cooperatively provide and present the artificial reality application in some examples. Application engine 320 may include, for example, one or more software packages, software libraries, hardware drivers, and/or Application Program Interfaces (APIs) for implementing an artificial reality application on console 106. Responsive to control by application engine 320, rendering engine 322 generates 3D artificial reality content for display to the user by application engine 340 of HMD 112.

Rendering engine 322 renders the artificial content constructed by application engine 320 for display to user 101 in accordance with current pose information for a frame of reference, typically a viewing perspective of HMD 112, as determined by pose tracker 326. Based on the current viewing perspective, rendering engine 322 constructs the 3D, artificial reality content which may be overlaid, at least in part, upon the physical 3D environment in which HMD 112 is located. During this process, pose tracker 326 may operate on sensed data received from HMD 112, such as movement information and user commands, and, in some examples, data from external sensors 190 and/or cameras 192 (as shown in FIG. 1) to capture 3D information within the physical 3D environment, such as motion by HMD 112, a user thereof, a controller, and/or feature tracking information with respect to the user thereof.

Pose tracker 326 determines information relating to a pose of a user within a physical environment. For example, console 106 may receive mapping information from HMD 112, and mapping engine 328 may progressively generate a map for an area in which HMD 112 is operating over time, HMD 112 moves about the area. Pose tracker 326 may localize HMD 112, using any of the aforementioned methods, to the map for the area. Pose tracker 326 may also attempt to localize HMD 112 to other maps generated using mapping information from other user devices. At some point, pose tracker 326 may compute the local pose for HMD 112 to be in an area of the physical 3D environment that is described by a map generated using mapping information received from a different user device. Using mapping information received from HMD 112 located and oriented at the computed local pose, mapping engine 328 may join the map for the area generated using mapping information for HMD 112 to the map for the area generated using mapping information for the different user device to close the loop and generate a combined map for the master 3D map. Mapping engine 328 stores such information as map data 330. Based sensed data collected by external sensors 190, cameras 192, HMD 112, or other sources, pose tracker 326 determines a current pose for the frame of reference of HMD 112 and, in accordance with the current pose, provides such information to application engine 320 for generation of artificial reality content. That artificial reality content may then be communicated to HMD 112 for display to the user via electronic display 203.

Mapping engine 328 may be configured to generate maps of a physical 3D environment using mapping information received from user devices. Mapping engine 328 may receive the mapping information in the form of images captured by sensor devices 208 at local poses of HMD 112 and/or tracking information for HMD 112, for example. Mapping engine 328 processes the images to identify map points for determining topographies of the scenes in the images and use the map points to generate map data that is descriptive of an area of the physical 3D environment in which HMD 112 is operating. Map data 330 may include at least one master 3D map of the physical 3D environment that represents a current best map, as determined by mapping engine 328 using the mapping information.

Mapping engine 328 may receive images from multiple different user devices operating in different areas of a physical 3D environment and generate different maps for the different areas. The different maps may be disjoint in that the maps do not, in some cases, overlap to describe any of the same areas of the physical 3D environment. However, the different maps may nevertheless be different areas of the master 3D map for the overall physical 3D environment.

Pose tracker 326 determines information relating to a pose of a user within a physical environment. For example, console 106 may receive mapping information from HMD 112, and mapping engine 328 may progressively generate a map for an area in which HMD 112 is operating over time, HMD 112 moves about the area. Pose tracker 326 may localize HMD 112, using any of the aforementioned methods, to the map for the area. Pose tracker 326 may also attempt to localize HMD 112 to other maps generated using mapping information from other user devices. At some point, pose tracker 326 may compute the local pose for HMD 112 to be in an area of the physical 3D environment that is described by a map generated using mapping information received from a different user device. Using mapping information received from HMD 112 located and oriented at the computed local pose, mapping engine 328 may join the map for the area generated using mapping information for HMD 112 to the map for the area generated using mapping information for the different user device to close the loop and generate a combined map for the master 3D map. Mapping engine 328 stores that maps as map data 330. Based sensed data collected by external sensors 190, cameras 192, HMD 112, or other sources, pose tracker 326 determines a current pose for the frame of reference of HMD 112 and, in accordance with the current pose, provides such information to application engine 320 for generation of artificial reality content. That artificial reality content may then be communicated to HMD 112 for display to the user via electronic display 203.

Mapping engine 328 may use mapping information received from HMD 112 to update the master 3D map, which may be included in map data 330. Mapping engine 328 may, in some examples, determine whether the mapping information is preferable to previous mapping information used to generate the master 3D map. For example, mapping engine 328 may determine the mapping information is more recent in time, of higher resolution or otherwise better quality, indicates more or different types of objects, has been generated by a user device having higher resolution localization abilities (e.g., better inertial measurement unit or navigation system) or better optics or greater processing power, or is otherwise preferable. If preferable, mapping engine 328 generates an updated master 3D map from the mapping information received from HMD 112. Mapping engine 328 in this way progressively improves the master 3D map.

In some examples, mapping engine 328 may generate and store health data in association with different map data of the master 3D map. For example, some map data may be stale in that the mapping information used to generate the map data was received over an amount of time ago, or the map data may be of poor quality in that the images used to the generate the map data were poor quality (e.g., poor resolution, poor lighting, etc.). These characteristics of the map data may be associated with relatively poor health. Contrariwise, high quality mapping information would be associated with relatively good health. Health values for map data may be indicated using a score, a descriptor (e.g., “good,” “ok,” “poor”), a date generated, or other indicator. In some cases, mapping engine 328 may update map data of the master 3D map for an area if the health for the map data satisfies a threshold health value (e.g., is below a certain score). If the threshold health value is satisfied, mapping engine 328 generates an updated area for the area of the master 3D map using the mapping information received from HMD 112 operating in the area. Otherwise, mapping engine 328 discards the mapping information.

Controller-enabled application 321 may be a routine, mode, application, or other module that may use an object for input or for another purpose. In some examples, controller-enabled application 321 may represent an application, such as an artificial reality game, that requires the use of controllers as input devices. In another example, controller-enabled application 321 may be an artificial reality application that is capable of operating using controllers as input devices, but where such controllers are not required. In yet another example, controller-enabled application 321 may be an artificial reality or other application that requires or optionally enables use of a physical object in some way in connection with the artificial reality application. In such an example, such an object might not be a controller or other input device, but may be some other physical object.

In some examples, map data 330 includes different master 3D maps for different areas of a physical 3D environment. Pose tracker 326 may localize HMD 112 to a location in one of the areas using images received from HMD 112. In response, application engine 320 may select the master 3D map for the area within which pose tracker 326 localized HMD 112 and send the master 3D map to HMD 112 and/or object 111 for use in the artificial reality application. Consequently, HMD 112 may generate and render artificial reality content using the appropriate master 3D map for the area in which HMD 112 is located.

In some examples, map data includes different master 3D maps for the same area of a physical 3D environment, the different master 3D maps representing different states of the physical environment. For example, a first master 3D map may describe an area at a first time e.g., August 2015, while a second master 3D map may describe the area at a second time, e.g., October 2016. Application engine 320 may determine to use the first master 3D map responsive to a request from the user or responsive to determining that a user may wish to locate a physical object within an artificial reality application, for instance. The mapping engine 328 may indicate in map data 330 that the first master 3D map is the master 3D map that is to be used for rendering artificial reality content for an artificial reality application. In this way, an artificial reality system including console 106 can render artificial reality content using historical map data describing a physical 3D environment as it appeared in earlier times. This technique may be advantageous for education-related artificial reality applications, for instance.

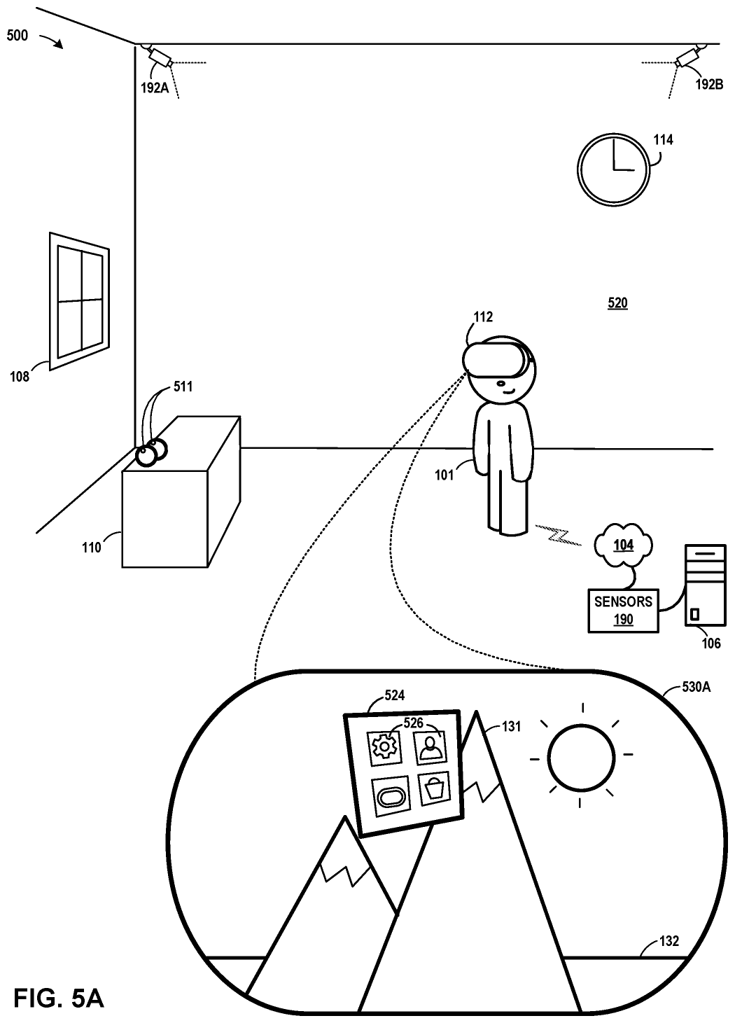

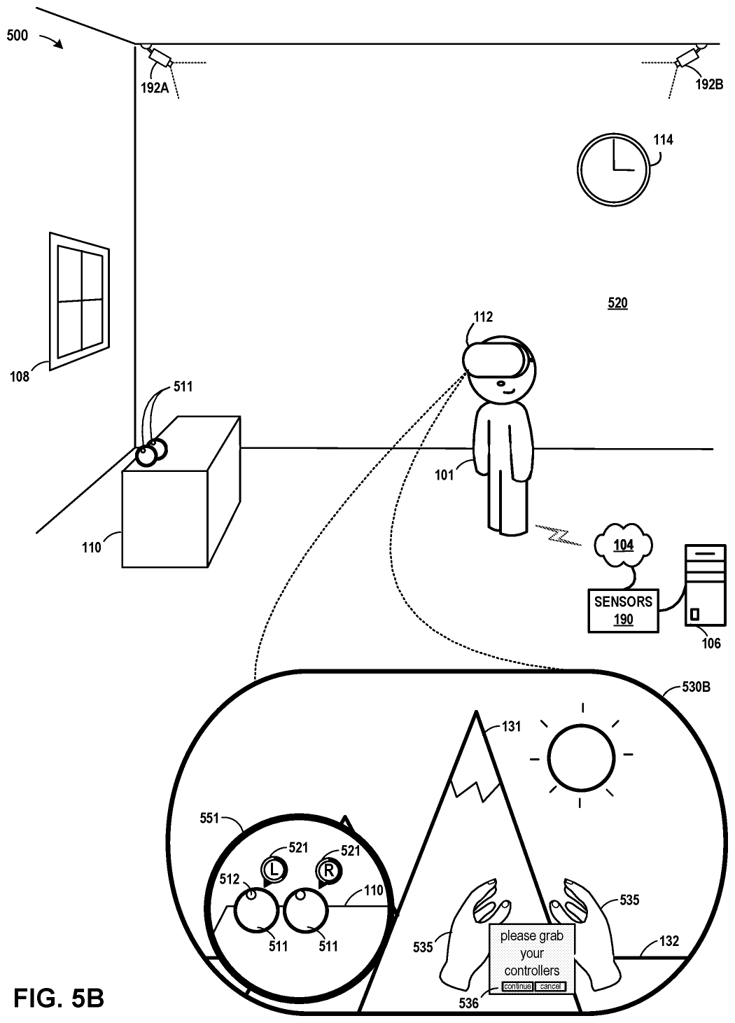

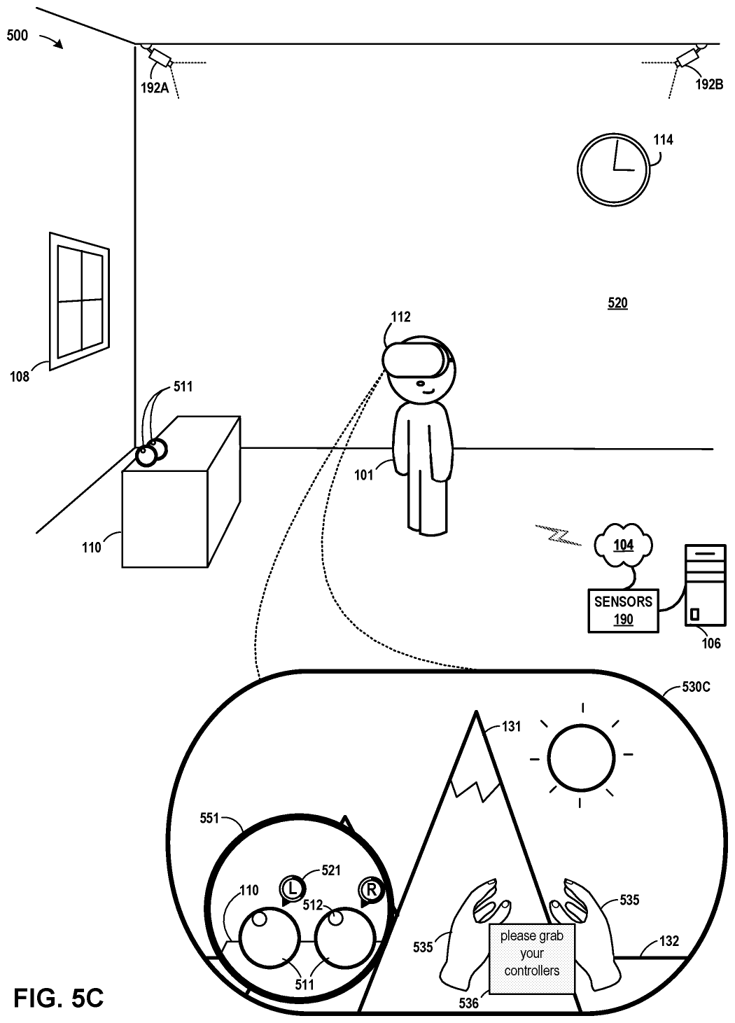

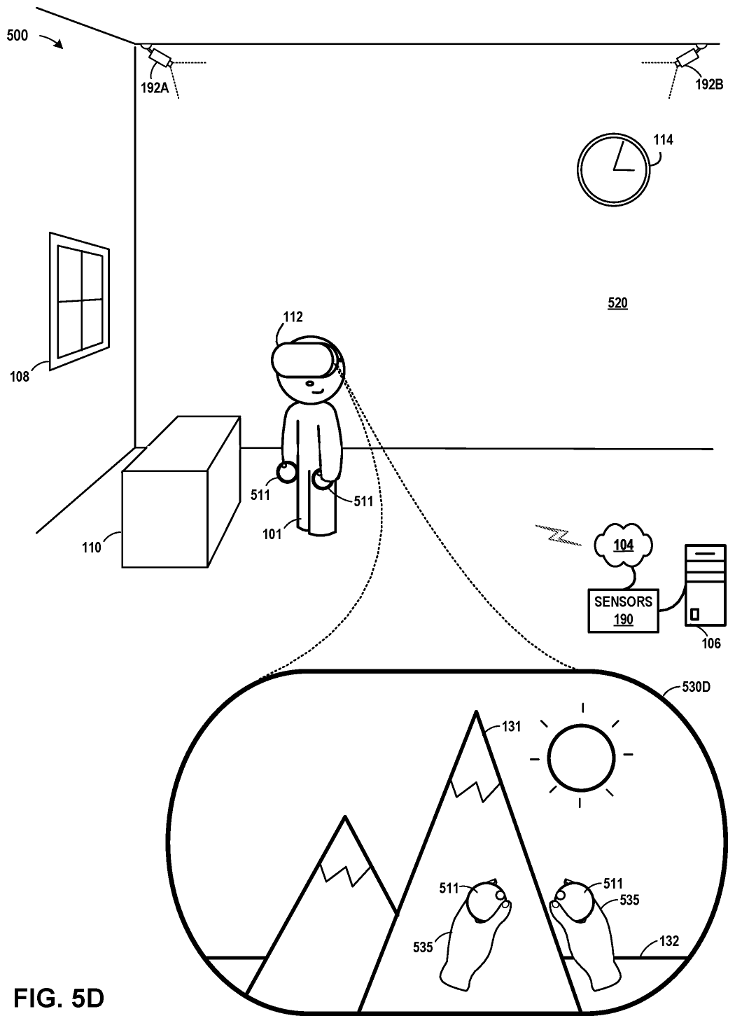

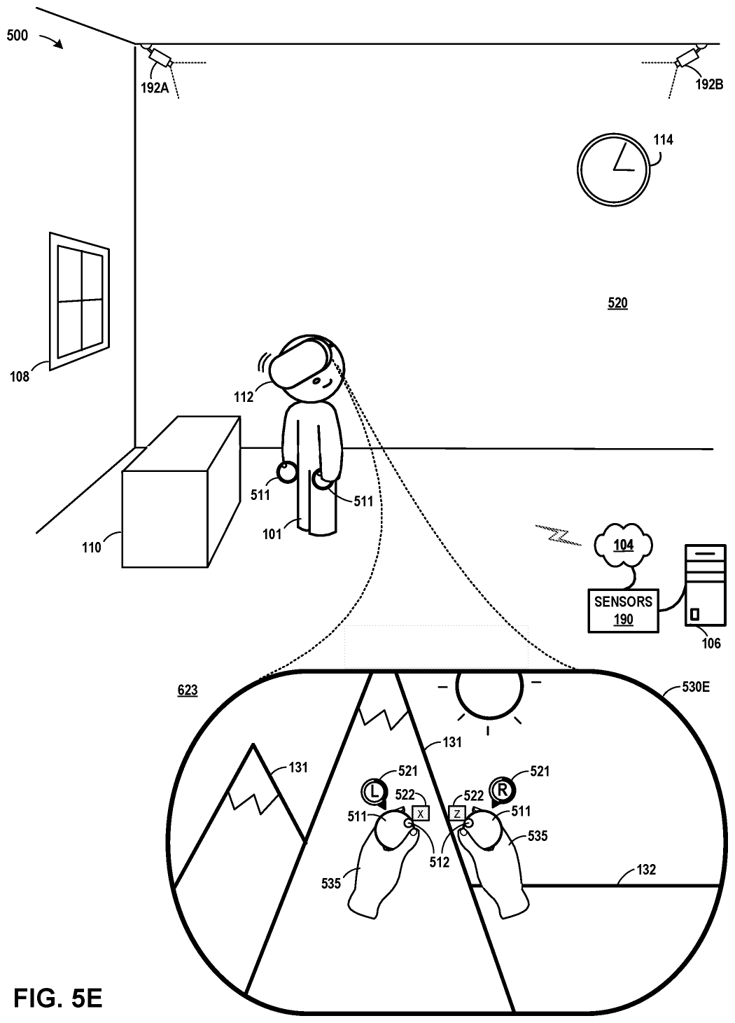

User interface engine 329 may perform functions relating to generating a user interface when a user is seeking to locate a specific object (e.g., object 111 or controllers 511, as illustrated in FIG. 5A through FIG. 5E). User interface engine 329 may receive information from application engine 320, pose tracker 326, and/or mapping engine 328 and based on that information, generate a user interface (e.g., user interface menu 124 having user interface elements 126). User interface engine 329 may output, to rendering engine 322, information about the user interface so that rendering engine 322 may present the user interface, overlaid on other physical and/or artificial reality content, at display 203 of HMD 112. Accordingly, user interface engine 329 may receive information from and output information to one or more other modules, and may otherwise interact with and/or operate in conjunction with one or more other engines or modules of console 106.

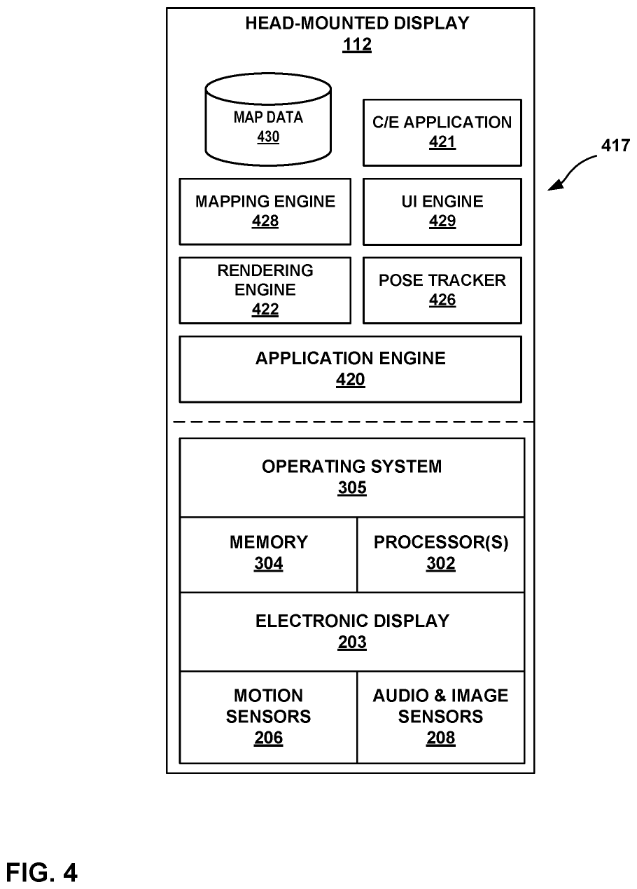

In some examples, such as in the manner described in connection with FIG. 4, some or all of the functionality attributed to pose tracker 326, rendering engine 322, configuration interface 332, classifier 324, and application engine 320 may be performed by HMD 112.

Modules or engines illustrated in FIG. 3 (e.g., operating system 316, application engine 320, controller-enabled application 321, rendering engine 322, pose tracker 326, mapping engine 328, user interface engine 329, controller-enabled application 321, operating system 305, and application engine 306), FIG. 4, and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

FIG. 4 is a block diagram depicting an example of a user device for an artificial reality system, in accordance with one or more aspects of the present disclosure. In FIG. 4, HMD 112 may operate as a stand-alone device, i.e., not tethered to a console, and may represent an instance of any of the user devices, including HMD 112 described in connection with FIG. 1. Although device 112 illustrated in FIG. 4 is primarily described as a head-mounted device, the device illustrated in FIG. 4 may, in other examples, be implemented as a different device, such as tablet computer, for instance. In the specific example of FIG. 4, however, and in a manner similar to FIG. 3, HMD 112 includes one or more processors 302 and memory 304 that, in some examples, provide a computer platform for executing an operation system 305, which may be an embedded multitasking operating system. In turn, operating system 305 provides an operating environment for executing one or more software components 417. Moreover, processor(s) 302 are coupled to electronic display 203, motion sensors 206, and sensor devices 208.

In the example of FIG. 4, software components 417 operate to provide an overall artificial reality application. In this example, software components 417 include application engine 420, rendering engine 422, pose tracker 426, mapping engine 428, user interface (UI) engine 429, and controller-enabled application 421. In various examples, software components 417 operate similar to the counterpart components of console 106 of FIG. 3 (e.g., application engine 320, rendering engine 322, pose tracker 326, mapping engine 328, user interface engine 329, and controller-enabled application 421).

One or more aspects of FIG. 4 may be described herein within the context of other Figures, including FIG. 1 and FIG. 5A through FIG. 5E. In various examples, HMD 112 may generate map information, determine a pose, detect input, identify one or more objects, determine a user may be seeking to locate one or more objects 111 or controllers 511, and present artificial reality content with a passthrough window that reveals the location of one or more objects 111 or controllers 511, or otherwise provides information about how to locate one or more objects 111 or controllers 511. In some examples, such a passthrough window presents an image of the physical world, enabling a user to see the actual location of such objects and/or controllers.

In accordance with one or more aspects of the present disclosure, HMD 112 of FIG. 1 and FIG. 4 may generate map information. For instance, in an example that can be described with reference to FIG. 1 and FIG. 4, each of external sensors 190, cameras 192, sensor devices 208 collect information about physical environment 120. External sensors 190 and cameras 192 communicate the information each collects to HMD 112, and such information may be communicated to HMD 112 over network 104 or through other means. HMD 112 receives information from external sensors 190 and/or cameras 192 and outputs to mapping engine 428 information about physical environment 120. Sensor devices 208 of HMD 112 also collect information about physical environment 120, and output to mapping engine 428 information about physical environment 120. Mapping engine 428 determines, based on the information received from external sensors 190, cameras 192, and/or sensor devices 208, a map of physical environment 120. Mapping engine 428 stores information about the map as map data 430.

HMD 112 may determine pose information. For instance, referring again to FIG. 1 and FIG. 4, motion sensor 206 and/or sensor devices 208 detect information about the position, orientation, and/or location of HMD 112. Pose tracker 426 receives from mapping engine 428 information about the position, orientation, and/or location of HMD 112. Pose tracker 426 determines, based on this information, a current pose for a frame of reference of HMD 112.

HMD 112 may identify one or more objects within physical environment 120. For instance, continuing with the example and with reference to FIG. 1 and FIG. 4, mapping engine 428 identifies, based on the information received from external sensors 190, cameras 192, and/or sensor devices 208, one or more physical objects, such as object 111. Mapping engine 428 outputs information to application engine 420. Application engine 420 updates map data 430 to reflect the objects identified, including object 111.

HMD 112 may present artificial reality content within HMD 112 while user 101 is standing. For instance, in FIG. 1 and with reference to FIG. 4, application engine 420 generates artificial reality content 130. Application engine 420 outputs information about artificial reality content 130 to rendering engine 422. Rendering engine 422 causes artificial reality content 130 to be presented at display 203 within HMD 112 in the manner shown in FIG. 1.

In FIG. 1, artificial reality content 130 may correspond to simply an image of physical environment 120, with little or no artificial reality content overlaid on physical environment 120. In the example shown, artificial reality content 130 includes artificial reality content, including one or more virtual mountains 131 towering over virtual horizon 132. As illustrated within artificial reality content 130, passthrough window 151 may provide a small window into physical environment 120. In other examples, artificial reality content 130 might include content showing primarily images or three-dimensional representations of objects in physical environment 120 (e.g., artificial content overlaid on window 108).

FIG. 5A, FIG. 5B, FIG. 5C, FIG. 5D, and FIG. 5E are conceptual diagrams illustrating an example artificial reality system that may use one or more controllers, in accordance with one or more aspects of the present disclosure. In each of FIG. 5A, FIG. 5B, FIG. 5C, FIG. 5D, and FIG. 5E, artificial reality system 500 is depicted within physical environment 520. Physical environment 520 is shown as a room that includes user 101 and a number of real-world or physical objects, including HMD 112, window 108, and table 110.

In the examples of FIG. 5A, FIG. 5B, FIG. 5C, FIG. 5D, and FIG. 5E, artificial reality system 500 includes many of the same elements described in artificial reality system 100 of FIG. 1. Elements illustrated in each of FIG. 5A, FIG. 5B, FIG. 5C, FIG. 5D, and FIG. 5E may correspond to elements illustrated in FIG. 1 that are identified by like-numbered reference numerals in FIG. 1. In general, such like-numbered elements may be implemented in a manner consistent with the description of the corresponding element provided in connection with FIG. 1 or elsewhere herein, although in some examples, such elements may involve alternative implementation with more, fewer, and/or different capabilities and attributes. Accordingly, artificial reality system 500 of FIG. 5A, FIG. 5B, FIG. 5C, FIG. 5D, and FIG. 5E may be described as an alternative example or implementation of artificial reality system 100 of FIG. 1. Further, some operations are described herein in the context of FIG. 4, but similar operations may be performed by other systems, including that illustrated in FIG. 3.

In accordance with one or more aspects of the present disclosure, HMD 112 may present artificial reality content. For instance, in an example that can be described with reference to FIG. 4 and FIG. 5A, application engine 420 of HMD 112 determines, based on mapping and pose information, that user 101 is standing within physical environment 520 at a distance from table 110, and facing the wall that includes window 108. Application engine 420 outputs mapping information, including information about user 101, to user interface engine 429. User interface engine 429 generates information underlying artificial reality content 530A. In some examples, user interface engine 429 uses aspects of images captured by sensors 208 of HMD 112 to generate artificial reality content 530A. User interface engine 429 outputs the information underlying artificial reality content 530A to application engine 420. Application engine 420 outputs information about artificial reality content 530A to rendering engine 422. Rendering engine 422 causes artificial reality content 530A to be presented at display 203 within HMD 112 in a manner similar to that shown in FIG. 5A.

HMD 112 may include user interface menu 524 within artificial reality content 530A. For instance, continuing with the example being described in the context of FIG. 4 and FIG. 5A, application engine 420 determines that motion by user 101 or gestures performed by user 101 correspond to a request to modify one or more aspects of artificial reality system 500. In response to such a determination, application engine 420 outputs information to user interface engine 429. User interface engine 429 generates information underlying a user interface and outputs such information to application engine 420. Application engine 420 updates artificial reality content 530A to include user interface menu 524, which includes one or more user interface elements 526. Application engine 420 outputs information about updated artificial reality content 530A to rendering engine 422. Rendering engine 422 causes artificial reality content 530A, updated to include user interface menu 524, to be presented in the manner shown in FIG. 5A.

In FIG. 5A, artificial reality content 530A includes virtual content, including, for example, one or more virtual mountains 131 along virtual horizon 132. User interface menu 524 is overlaid on such virtual content in artificial reality content 530A. In the example shown, few or no physical objects are illustrated or represented within artificial reality content 530A. In other examples, representations of one or more physical objects within physical environment 520 may be presented.

HMD 112 may respond to interactions with user interface menu 524. For instance, continuing with the example and with reference to FIG. 4 and FIG. 5A, application engine 420 detects movement by user 101 or gestures performed by user 101 indicating interaction with user interface menu 524. Application engine 420 further determines that the movement or gestures indicate that the user seeks to launch an application or change a mode or setting in a currently-executing application. Application engine 420 performs an operation in response to the user's interactions with user interface menu 524, such as launching controller-enabled application 421. In the example being described, controller-enabled application 421 is an application that requires use of controllers 511. In some examples, application engine 420 may change a mode or other setting for a currently-executing application, rather than launching controller-enabled application 421. In such an example, such a mode change may also cause the currently-executing application to require use of controllers 511.

HMD 112 may determine that controller-enabled application 421 operates using one or more controllers. For instance, still continuing with the example and referring to FIG. 4 and FIG. 5A, and in connection with launching controller-enabled application 421 in response to interactions with user interface menu 524, application engine 420 determines that controller-enabled application 421 operates in response to use of controllers 511. In the example being described, controller-enabled application 421 requires use of controllers 511. In other examples, controller-enabled application 421 may operate without use of controllers, but may support input to and/or interactions with controller-enabled application 421 through controllers 511 (e.g., use of controllers 511 may be optional). In some examples, HMD 112 may pair with controllers 511 (e.g., through Bluetooth communications or otherwise). Such pairing or other initialization routine may occur when artificial reality system 100 is started, when HMD 112 determines that controller-enabled application 421 operates using one or more controllers, or at a different time.

HMD 112 may determine that user 101 does not possess controllers 511. For instance, still continuing with the example being described, and still referring FIG. 4 and FIG. 5A, application engine 420 determines, based on mapping and pose information, that user 101 does not possess controllers 511. Alternatively, or in addition, application engine 420 may determine, based on image data captured by sensors 208 of HMD 112, that user 101 does not possess controllers 511. Application engine 420 further determines, based on the mapping information and/or the image information, that controllers 511 are resting on table 110 in front of user 101.

HMD 112 may present artificial reality content assisting user 101 in locating controllers 511. For instance, still continuing with the example and referring now to FIG. 4 and FIG. 5B, application engine 420 outputs information about controller-enabled application 421 and/or controllers 511 to user interface engine 429. User interface engine 429 generates information underlying artificial reality content 530B. In some examples, user interface engine 429 uses images captured by sensors 208 of HMD 112, sensors 190, and/or cameras 192 to generate artificial reality content. User interface engine 429 outputs the information underlying artificial reality content 530B to application engine 420. Application engine 420 outputs information about artificial reality content 530B to rendering engine 422. Rendering engine 422 causes artificial reality content 530B to be presented at display 203 within HMD 112 in the manner shown in FIG. 5B.

In FIG. 5B, artificial reality content 530B includes much of the artificial reality content included within artificial reality content 530A of FIG. 5A. In addition, however, artificial reality content 530B includes a virtual representation of each of the hands of user 101 (e.g., virtual hands 535). In FIG. 5B, virtual hands 535 are shown without controllers 511, since artificial reality system 100 determined that user 101 does not possess controllers 511. Artificial reality content 530B also includes prompt 536, directing user 101 to grab controllers 511. In some examples, prompt 536 may include user interface elements (e.g., “continue” and “cancel” buttons) that enable user 101 to continue (e.g., dismiss prompt 536 after user 101 grabs controllers 511) or cancel (e.g., dismiss prompt 536 without user 101 grabbing controllers 511).

Artificial reality content 530B further includes passthrough window 551, which provides a view into physical environment 520. Passthrough window 551 may, for example, present an image captured by sensors 208 of HMD 112 (see FIG. 2), which may present a physical environment view of controllers 511 from the perspective of HMD 112. When generating artificial reality content 530B, user interface engine 429 of HMD 112 generates information underlying artificial reality content 530B so that passthrough window 551 is based on and/or includes an image of the physical world, and in addition, is appropriately positioned within artificial reality content 530B. In some examples, user interface engine 429 generates artificial reality content 530B and positions passthrough window 551 within artificial reality content 530B so that, if possible, controllers 511 are visible within passthrough window 551. As illustrated in artificial reality content 530B, a passthrough or physical view of controllers 511 is shown within passthrough window 551, with controllers 511 shown near the edge of table 110 within passthrough window 551. In the example illustrated in FIG. 5B, one passthrough window 551 is illustrated. However, in other examples, more than one passthrough window 551 may be used, particularly where multiple controllers 511 are to be located, and where they do not happen to be near each other.

In addition, when generating information underlying artificial reality content 530B, user interface engine 429 may also include augmented reality markers within passthrough window 551. In the example of FIG. 5B, and as illustrated within passthrough window 551 of artificial reality content 530B, such augmented reality markers may include one or more indicators 521. In FIG. 5B, one indicator 521 is shown near each of controllers 511. Each of indicators 521, as shown in artificial reality content 530B of FIG. 5B, indicates whether each of controllers 511 is the left controller or the right controller (indicated using characters “L” and “R).

In some examples, each of indicators 521 may provide additional information about each respective controller 511. For example, in FIG. 5B, each of indicator 521 includes a ring that is partially filled, which may indicate the extent to which a battery associated with each of controllers 511 is charged. In some examples, an unfilled ring may indicate low battery life; a fully-filled ring may indicate a full battery charge. In the example of FIG. 5B, therefore, indicator 521 for the right controller 511 appears to have a slightly higher level of battery charge than is indicated by indicator 521 for the left controller 511. To obtain the battery status information, HMD 112 may query each of controllers 511 when initializing, pairing, or otherwise communicating with controllers 511.

HMD 112 may update artificial reality content 530B when user 101 moves toward controllers 511. For instance, still continuing with the example being described and referring now to FIG. 4, FIG. 5B, and FIG. 5C, application engine 420 detects, based on motion detected by cameras 192 and/or mapping engine 428, that user 101 has moved closer to table 110 and controllers 511. Application engine 420 outputs information about the movement to user interface engine 429. User interface engine 429 generates information underlying artificial reality content 530C. User interface engine 429 outputs the information underlying artificial reality content 530C to application engine 420. Application engine 420 causes rendering engine 422 to present artificial reality content 530C at display 203 within HMD 112 in the manner shown in FIG. 5C.

In FIG. 5C, artificial reality content 530C includes many of the same elements of artificial reality content 530B of FIG. 5B. In FIG. 5C, however, within passthrough window 551 controllers 511 have become larger, reflecting the closer distance between user 101 and controllers 511 after user 101 has moved toward table 110. In the example of FIG. 5C, the virtual content (e.g., virtual mountains 131, virtual horizon 132) within artificial reality content 530C has not changed in size, even though user 101 has moved toward the wall within physical environment 520 that includes window 108. In other examples, however, virtual content presented within artificial reality content 530C may change in response to movements by user 101.

HMD 112 may determine that user 101 is holding controllers 511. For instance, still continuing with the example being described and referring now to FIG. 4, FIG. 5C, and FIG. 5D, application engine 420 detects further motion of user 101, and determines that user 101 has again moved closer to table 110 and controllers 511. Application engine 420 further detects that user 101 has grabbed or picked up controllers 511 and user 101 is holding controllers 511. Application engine 420 outputs information about user 101 and controllers 511 to user interface engine 429. User interface engine 429 generates information underlying artificial reality content 530D. Application engine 420 causes rendering engine 422 to present artificial reality content 530D at display 203 within HMD 112 in the manner illustrated in FIG. 5D.

In FIG. 5D, artificial reality content 530D illustrates each of virtual hands 535 holding one of controllers 511. Artificial reality content 530D also no longer includes passthrough window 551. In some examples, virtual hands 535 holding controllers 511 may be presented within artificial reality content 530D for a period of time to provide visual confirmation that artificial reality system 500 has recognized that controllers 511 are now in the possession of user 101. In such an example, virtual hands 535 and/or controllers 511 may be removed from artificial reality content 530D after the period of time expires. In other examples, artificial reality content 530D may continue to present virtual hands 535 holding passthrough windows 551. Further, in examples where virtual hands 535 and controllers 511 continue to be presented, indicators 521 may also continue to be presented for each of controllers 511. In the example of FIG. 5D, however, indicators 521 are not included within artificial reality content 530D.

HMD 112 may determine that the gaze of user 101 is directed toward controllers 511 as user 101 holds controllers 511. For instance, in an example that can be described in the context of FIG. 4 and FIG. 5E, application engine 420 detects movement of HMD 112, and determines that user 101 has altered his or her gaze so that user 101 is looking at controllers 511. In some examples, this may mean that user 101 is looking down, so that the field of view of user 101 is centered on a region that includes controllers 511. In such an example, application engine 420 outputs information about a pose of user 101 to user interface engine 429. User interface engine 429 generates information underlying artificial reality content 530E. User interface engine 429 determines, based on the pose information received from application engine 420, that virtual hands 535 and controllers 511 are substantially within the center of the field of view of user 101. In response to such a determination, user interface engine 429 includes within the information underlying artificial reality content 530E information sufficient to include indicators 521. In addition, user interface engine 429 may, in some examples, include within the information underlying artificial reality content 530E additional information about controllers 511. Application engine 420 causes rendering engine 422 to present artificial reality content 530E at display 203 within HMD 112 in the manner illustrated in FIG. 5E.

In FIG. 5E, virtual hands 535 are presented within the center of artificial reality content 530E, appropriately corresponding to the pose of user 101. Each of controllers 511 are presented with an indicator 521, each of which may be similar to indicators 521 illustrated in connection with artificial reality content 530C of FIG. 5C. In addition, in the example of FIG. 5E, one or more button mapping indicators 522 may also be included within artificial reality content 530E. In some examples, each of button mapping indicators 522 may provide information about a button function or a button mapping for controllers 511. Although controllers 511 are shown with only a single button, each of controllers 511 may include any number of buttons, and in such an example, button mapping indicators 522 may be presented within artificial reality content 530E for each such button. Further, although button mapping indicators 522 are shown providing a single character of information, more descriptive button mapping information may be provided in other examples. Such button mapping information may change depending on a mode of controller-enabled application 421 or based on other information. In some examples, application engine 420 and/or user interface engine 429 may cause rendering engine 422 to cease presentation of indicators 521 and/or button mapping indicators 522 in response to detecting that virtual hands 535 and/or controllers 511 are no longer in the center of the gaze of user 101.

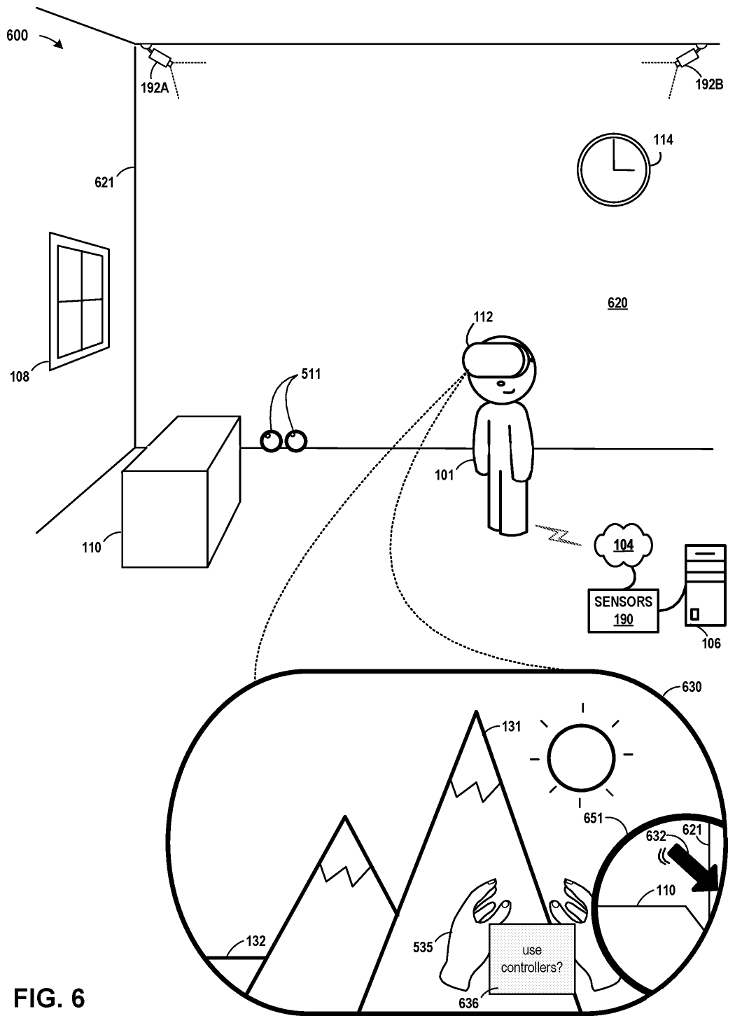

FIG. 6 is a conceptual diagram illustrating an example artificial reality system that generates artificial reality content that assists in finding one or more objects not within a field of view of user 101. FIG. 6 is similar to FIG. 5A, FIG. 5B, FIG. 5C, FIG. 5D, and FIG. 5E, and includes artificial reality system 600 deployed within physical environment 620. Physical environment 620 includes user 101 and table 110 with user 101 wearing HMD 112. User 101 is facing the wall that includes window 108. To the right of user 101 is a wall that includes wall clock 114. Edge 621 represents the vertical edge formed by the wall that includes window 108 and the wall that includes wall clock 114.

Physical environment 620 of FIG. 6 also includes controllers 511, but unlike in other illustrations herein, controllers 511 are not located on table 110. Instead, in the example of FIG. 6, controllers 511 are on the floor along the wall that includes wall clock 114. Some operations are described herein with reference to FIG. 6 and in the context of a system implemented pursuant to FIG. 4, but similar operations may be performed in other systems, including that illustrated in FIG. 3.

In accordance with one or more aspects of the present disclosure, HMD 112 may determine that user 101 may wish to locate controllers 511. For instance, in an example that can be described in the context of FIG. 4 and FIG. 6, application engine 420 determines, based on mapping and pose information, that user 101 is standing within physical environment 620 facing that wall that includes window 108. Application engine 420 outputs mapping information about physical environment 620 to user interface engine 429. Such mapping information may include position and pose information for user 101, as well as information about the location of controllers 511. User interface engine 429 generates information for a user interface. Application engine 420 further outputs, to user interface engine 429, information about a mode of a currently executing application indicating that use of controllers 511 is optional for the currently-executing application.

HMD 112 may present artificial reality content that assists user 101 in finding controllers 511. For instance, continuing with the example being described, user interface engine 429 of HMD 112 uses the information about the mode of a currently executing application to generate further information for the user interface, including information underlying a user interface that may assist user 101 in locating controllers 511. User interface engine 429 outputs to application engine 420 information underlying artificial reality content 630. Application engine 420 outputs information about artificial reality content 630 to rendering engine 422. Rendering engine 422 causes artificial reality content 630 to be presented at display 203 within HMD 112 in the manner illustrated in FIG. 6.

In FIG. 6, artificial reality content 630 includes virtual content, including virtual mountains 131 and virtual horizon 132, along with virtual hands 535. Artificial reality content 630 further includes passthrough window 651, providing a view into physical environment 620. In passthrough window 651, the right-hand corner of table 110 is visible, along with edge 621. Based on the position, pose, and gaze of user 101, controllers 511 are not included within the view represented by artificial reality content 630. Accordingly, passthrough window 651 includes arrow 632, which indicates the direction, outside the view of user 101, where controllers 511 can be found. In FIG. 6, arrow 632 points down and to the right, because based on the position, pose, and gaze of user 101, controllers 511 are located down and to the right relative to the field of view represented by artificial reality content 630. In some examples, arrow 632 may be animated, which may help user 101 notice arrow 632. In some examples, artificial reality content 630 does not include passthrough window 651 if controllers 511 are not within a field of view of user 101. In response to detecting that controllers 511 are within a field of view of user 101, due to changes in the pose of HMD 112 or movement by controllers 511 for instance, artificial reality system 600 may update artificial reality content 630 to include passthrough window 651. As can be partially seen in FIG. 6, passthrough window 651 may move (e.g. slide) into artificial reality content 630, e.g., as user 101 turns toward controllers 511 or controllers 511 otherwise move into the field of view of user 101.

Application engine 420 may detect movements by user 101 (e.g., adjusting the gaze of user 101 down and to the right). In response, application engine 420 and/or user interface engine 429 may update artificial reality content 630 so that the position and the portion of physical environment 620 that is presented within passthrough window 651 corresponds to the position, pose, and gaze of user 101. In some examples, the position of passthrough window 651 within artificial reality content 630 may move, corresponding to changes in the position, pose, and gaze of user 101. Eventually, the position, pose, and gaze of user 101 may change enough so that controllers 511 may be presented within passthrough window 651. In such an example, controllers 511 may be presented with one or more indicators and/or button mapping indicators in a manner similar to that illustrated in FIG. 5B or FIG. 5C.

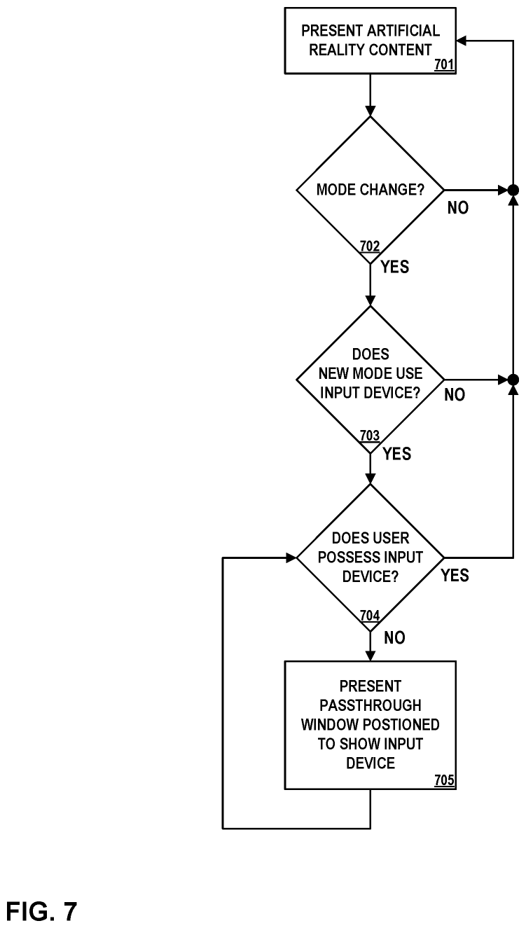

FIG. 7 is a flow diagram illustrating operations performed by an example artificial reality console 106 in accordance with one or more aspects of the present disclosure. FIG. 7 is described herein within the context of artificial reality system 100 of FIG. 1. In other examples, operations described in FIG. 7 may be performed by one or more other components, modules, systems, or devices. Further, in other examples, operations described in connection with FIG. 7 may be merged, performed in a difference sequence, omitted, or may encompass additional operations not specifically illustrated or described.

In the process illustrated in FIG. 7, and in accordance with one or more aspects of the present disclosure, console 106 may present artificial reality content (701). For instance, in an example that can be described with reference to FIG. 1, HMD 112, external sensors 190, and/or cameras 192 capture images within physical environment 120. Console 106 receives such images and determines the position of physical objects within physical environment 120, including user 101, HMD 112, table 110, and object 111. Console 106 generates map data (e.g., map data 330 in FIG. 3) representing the physical environment. Console 106 generates artificial reality content and causes the content to be presented within HMD 112.

Console 106 may determine whether a mode change has occurred (702). For instance, continuing with the example being described, HMD 112 may detect input that may involve interactions with one or more user interface elements included within user interfaces presented by HMD 112. HMD 112 may output information about the detected input to console 106. Console 106 may determine, based on information about the detected input, whether the input corresponds to a request to launch a new application or change a mode in a current application (YES path from 702) or does not correspond such a request (NO path from 702).

Console 106 may determine whether the new mode uses an input device (703). For instance, continuing with the example, console 106 may determine that the application being launched or the mode change uses a specific input device. In the example being described, object 111 illustrated in FIG. 1 may serve as the input device for the application. In some examples, object 111 may be a controller, stylus, or other input device.

Console 106 may determine whether the user possesses the input device (704). For instance, still continuing with the example being described in the context of FIG. 1 and FIG. 7, console 106 determines, based on information about the location of object 111 (i.e., input device 111) whether object 111 is positioned such that it is within a hand of object 111. In some examples, console 106 may receive updated mapping information about physical environment 120 to enable console 106 to make such a determination as mapping information changes. In the example being described, console 106 determines that object 111 is not in the possession of user 101 (NO path of 704). If console 106 did determine that object 111 was in the possession of user 101, console 106 may continue to present artificial reality content (YES path from 704).

Console 106 may present a passthrough window positioned to show the input device (705). For instance, again continuing with the example, console 106 generates information underlying artificial reality content 130 including passthrough window 151 providing information about the location of object 111 within physical environment 120. Console 106 causes artificial reality content 130 to be presented within HMD 112. In some examples, console 106 may update artificial reality content 130 as mapping information associated with physical environment 120 changes. Console 106 may continue to present artificial reality content 130 or updated artificial reality content 130 until user 101 possesses object 111. Console 106 may eventually determine that user 101 possesses object 111 (YES path from 704). In response to such a determination, console 106 may cease presentation of passthrough window 151.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices (e.g., HMD 112, console 106, external sensors 190, cameras 192, networks 104, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein (e.g., FIG. 1, FIG. 2, and/or FIG. 3) as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

The techniques described in this disclosure may be implemented, at least in part, in hardware, software, firmware or any combination thereof. For example, various aspects of the described techniques may be implemented within one or more processors, including one or more microprocessors, DSPs, application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

As described by way of various examples herein, the techniques of the disclosure may include or be implemented in conjunction with an artificial reality system. As described, artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some examples, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

1-20. (canceled)

21. A system comprising:
a head-mounted display (HMD) that is capable of being worn by a user, wherein the HMD includes at least one camera configured to capture a field of view of a physical environment, and the captured field of view is based on a pose of the HMD in the physical environment; and
processing circuitry configured to:
based on a location of an object, determine that the object is not within a first field of view captured by the at least one camera with the HMD in a first pose in the physical environment;
generate, based on the determination that the object is not within the first field of view, artificial reality content that provides an indication of the location of the object outside the first field of view;
output, for display by the HMD, the artificial reality content;
after outputting the artificial reality content, determine that the object is within a second field of view captured by the at least one camera with the HMD in a second pose in the physical environment, wherein the second pose of the HMD is different from the first pose of the HMD;
responsive to determining that the object is within the second field of view, generate updated artificial reality content that provides an indication of the location of the object in the second field of view; and
output, for display by the HMD, the updated artificial reality content.

22. The system of claim 21,
wherein the pose of the HMD in the physical environment comprises a location and an orientation of the HMD in the physical environment.

23. The system of claim 21,
wherein the indication of the location of the object is a directional indication of the location of the object.

24. A system of claim 21, wherein to generate the updated artificial reality content, the processing circuitry is further configured to:
generate artificial reality content that defines a window at least partially surrounding a view of the object in the physical environment.

25. The system of claim 24, wherein to generate the artificial reality content that defines the window, the processing circuitry is further configured to:
generate artificial reality content that at least partially obscures the physical environment but includes the window as a passthrough window providing a view of a portion of the physical environment.

26. The system of claim 25, wherein to generate the artificial reality content that defines the passthrough window, the processing circuitry is further configured to:
generate artificial reality content that positions the passthrough window to include the object and at least partial surroundings of the object in the physical environment.

27. The system of claim 21, wherein the object is a pair of objects, and wherein the pair of objects includes a left object capable of being held by a left hand of the user, and a right object capable of being held by a right hand of the user, and wherein to generate the updated artificial reality content, the processing circuitry is further configured to:
generate artificial reality content that identifies which of the pair of objects is the right object or which of the pair of objects is the left object.

28. The system of claim 21, wherein to generate the updated artificial reality content, the processing circuitry is further configured to:
generate artificial reality content prompting the user to grasp the object.

29. The system of claim 21, wherein to generate the updated artificial reality content, the processing circuitry is further configured to:
generate artificial reality content that includes information about the object, including at least one of: a battery status, a device type, or a button mapping assignment.

30. The system of claim 21, wherein to generate the updated artificial reality content, the processing circuitry is further configured to generate artificial reality content that defines a window at least partially surrounding a view of the object in the physical environment, and wherein the processing circuitry is further configured to:
determine that the object is possessed by the user;
after determining that the object is possessed by the user, generate further updated artificial reality content that omits the window; and
output, for display by the HMD, the further updated artificial reality content.

31. The system of claim 21, the processing circuitry is further configured to:
capture image data using the at least one camera; and
determine a map of the physical environment based on the captured image data, wherein the location of the object is determined based on the map.

32. A non-transitory computer-readable medium comprising instructions that, when executed, cause processing circuitry of a computing system to:
determine position information about an object in a physical environment, the position information including a location of the object;
determine that the object is not within a field of view defined by at least one camera of a head-mounted display (HMD);
generate, based on the determination that the object is not within the field of view of the HMD, artificial reality content that provides an indication of the location of the object outside the field of view of the HMD;
output, for display by the HMD, the artificial reality content;
after outputting the artificial reality content, determine that the field of view of the HMD has changed and the object is within the field of view of the HMD;
responsive to determining that the object is within the field of view of the HMD, generate updated artificial reality content that identifies the location of the object in the field of view of the HMD; and
output, for display by the HMD, the updated artificial reality content.

33. The non-transitory computer-readable medium of claim 32, wherein the instructions that configure the processing circuitry to generate updated artificial reality content further include instructions that configure the processing circuitry to:
generate artificial reality content that defines a window at least partially surrounding the view of the object in the physical environment.

34. The non-transitory computer-readable medium of claim 33, wherein the instructions that configure the processing circuitry to generate updated artificial reality content further include instructions that configure the processing circuitry to:
generate artificial reality content that at least partially obscures the physical environment but includes the window as a passthrough window providing a view of a portion of the physical environment.

35. The non-transitory computer-readable medium of claim 34, wherein the instructions that configure the processing circuitry to generate updated artificial reality content further include instructions that configure the processing circuitry to:
generate artificial reality content that positions the passthrough window to include the object and at least partial surroundings of the object in the physical environment.

36. The non-transitory computer-readable medium of claim 32, wherein the object is a pair of objects, and wherein the pair of objects includes a left object capable of being held by a left hand of a user, and a right object capable of being held by a right hand of the user, and wherein the instructions that configure the processing circuitry to generate updated artificial reality content further include instructions that configure the processing circuitry to:
generate artificial reality content that identifies which of the pair of controllers is the right controller or which of the pair of controllers is the left controller.

37. The non-transitory computer-readable medium of claim 32, wherein the instructions that configure the processing circuitry to generate updated artificial reality content further include instructions that configure the processing circuitry to:
generate artificial reality content prompting a user to grasp the object.

38. The non-transitory computer-readable medium of claim 32, wherein the instructions that configure the processing circuitry to generate updated artificial reality content further include instructions that configure the processing circuitry to:
generate artificial reality content that includes information about the object, including at least one of: a battery status, a device type, or a button mapping assignment.

39. The non-transitory computer-readable medium of claim 32, wherein the updated artificial reality content defines a window at least partially surrounding the view of the object in the physical environment, and wherein the computer-readable medium further comprises instructions that cause the processing circuitry to:
determine that the object is possessed by a user;
after determining that the object is possessed by the user, generate further updated artificial reality content that omits the window; and
output, for display by the HMD, the further updated artificial reality content.

40. A method comprising:
determining position information about an object used by a user in a physical environment, the position information including a location of the object;
determining that the object is not within a field of view defined by at least one camera of a head-mounted display (HMD);
generating, based on the determination that the object is not within the field of view of the HMD, artificial reality content that provides an indication of the location of the object outside the field of view of the HMD;
outputting, for display by the HMD, the artificial reality content;
after outputting the artificial reality content, determining that the object is within the field of view of the HMD;
responsive to determining that the object is within the field of view of the HMD, generating updated artificial reality content that identifies the location of the object in the field of view of the HMD; and
outputting, for display by the HMD, the updated artificial reality content.
